(19) United States
(12) Patent Application Publication
(10) Pub. No.: US 2026/0178519 A1
(43) Pub. Date: Jun. 25, 2026

(54) INTEGRATED CIRCUIT AND MONITORING SYSTEM

(71) Applicant: Renesas Electronics Corporation, Tokyo (JP)

(72) Inventors: Hirofumi HATAHARA, Tokyo (JP); Hideaki HAYASHI, Tokyo (JP)

(21) Appl. No.: 19/297,141

(22) Filed: Aug. 12, 2025

(30) Foreign Application Priority Data
Oct. 23, 2024 (JP) 2024-186416

(51) Int. Cl. G06F 13/16; G06F 13/40

(52) U.S. Cl. CPC G06F 13/1673; G06F 13/4068

(57) ABSTRACT

An integrated circuit 1 comprises a processor 10, a memory 12 that holds data defined in the software 18 executed by the processor 10, a data cache 11 positioned between the processor 10 and the memory 12, and a recording circuit 13. The data cache 11 temporarily holds write data output from processor 10 to be written to memory 12. The recording circuit 13 is connected to the bus 20 between the processor 10 and the data cache 11 and records the write data.

### CROSS-REFERENCE TO RELATED APPLICATIONS

The disclosure of Japanese Patent Application No. 2024-186416 filed on Oct. 23, 2024, including the specification, drawings and abstract is incorporated herein by reference in its entirety.

### BACKGROUND

This disclosure relates to integrated circuits and monitoring systems and can be suitably used in systems that monitor data held in integrated circuits, such as those including data caches.

Conventionally, in integrated circuits that include processors and memory, the execution of software by the processor is verified. The processor updates the values of multiple variables by executing software. The data indicating the values of these variables is held in memory. Therefore, users verify the execution of the software by monitoring the data held in memory while the processor is executing the software.

Incidentally, the above disclosure has been described based on the general technical information known to the applicant regarding conventional technology. However, to the best of the applicant's knowledge, the applicant does not possess any information that should be disclosed as prior art literature information before the application.

### SUMMARY

In integrated circuits, a data cache may be placed between the processor and memory. The data cache temporarily holds write data output from the processor that is to be written to memory. That is, the write data is temporarily held only in the data cache and not in memory. Therefore, even if users monitor the data held in memory, they cannot accurately verify the execution of the software.

Other challenges and novel features will become apparent from the description of this specification and the accompanying drawings.

An integrated circuit according to one embodiment includes a processor, a first memory for storing data defined in software executed by the processor, and a data cache disposed between the processor and the first memory. The data cache temporarily holds write data output from the processor to be written to the first memory. The integrated circuit further comprises a recording circuit. The recording circuit is connected to a bus between the processor and the data cache and records the write data.

A monitoring system according to another embodiment includes an integrated circuit and a monitoring device. The integrated circuit includes a first processor, a first memory storing data defined in software executed by the first processor and a data cache disposed between the first processor and the first memory. The data cache temporarily holds write data output from the first processor to be written into the first memory. The integrated circuit further includes a recording circuit. The recording circuit is connected to a bus between the first processor and the data cache and records the write data. The monitoring device includes a data reader and a user interface. The data reader accesses the recording circuit to read the write data. The user interface visualizes transition of values of one or more valuables indicated by the write data.

According to the above embodiment or other embodiments, even in integrated circuits that include data caches, users can more accurately verify the execution of the software.

### BRIEF DESCRIPTION OF THE DRAWINGS

FIG. 1 is a diagram illustrating an example of the overall configuration of a monitoring system according to an embodiment.

FIG. 2 is a diagram illustrating the configuration of a monitoring system according to a reference form.

FIG. 3 is a diagram explaining the monitoring of data by the monitoring device.

FIG. 4 is a flowchart illustrating an example of the control processing flow of an integrated circuit according to a reference form.

FIG. 5 is a block diagram showing an overview of the internal configuration of the monitoring system according to the present embodiment.

FIG. 6 is a diagram illustrating the configuration of Example 1 of the monitoring system according to the present embodiment.

FIG. 7 is a diagram showing the storage status of data in Example 1.

FIG. 8 is a diagram illustrating an example of the first table.

FIG. 9 is a diagram illustrating the configuration of Example 2 of the monitoring system according to the present embodiment.

FIG. 10 is a diagram showing the storage status of data in Example 2.

FIG. 11 is a diagram illustrating an example of the second table.

FIG. 12 is a diagram explaining the effect of reducing communication volume between the monitoring device and the monitoring RAM.

FIG. 13 is a diagram illustrating the configuration of Example 3 of the monitoring system according to the present embodiment.

### DETAILED DESCRIPTION

Below, the embodiments of the present disclosure will be described in detail with reference to the drawings. Note that the same or equivalent components are denoted by the same reference numerals.

### <Overall Configuration of the Monitoring System>

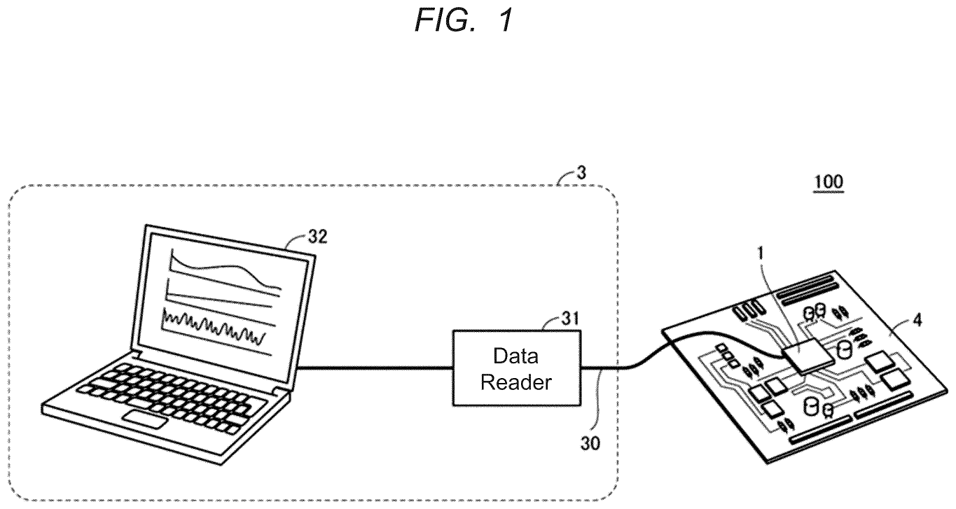

FIG. 1 is a diagram showing an example of the overall configuration of a monitoring system according to the embodiment. The monitoring system 100 includes an integrated circuit 1 and a monitoring device 3, as shown in FIG. 1.

The integrated circuit 1 is a semiconductor integrated circuit which includes a processor and a memory, and may include a system-on-chip (SoC) or a microcontroller unit (MCU). The integrated circuit 1 is mounted on e.g., a substrate 4, which is incorporated into a device to which control functions realized by the integrated circuit 1 are applied. The device may include e.g., electronic equipment, production equipment, and vehicles. The processor of the integrated circuit 1 executes software for realizing control functions.

A monitoring device 3 supports the verification of the software execution operation in the integrated circuit 1. The monitoring device 3 is used by the user to verify the execution operation of the software in the integrated circuit 1. When it is confirmed that there is no problem in software execution operation in the integrated circuit 1, the monitoring device 3 is removed from the integrated circuit 1.

The monitoring device 3 supports the verification of the software execution operation in the integrated circuit 1 by monitoring data held in the integrated circuit 1. The monitoring device 3 includes a debug interface 30 connected to the integrated circuit 1, a data reader 31 for reading data held in the integrated circuit 1 and an information processing device 32.

The information processing device 32 is a computer with a general-purpose architecture. The information processing device 32 includes, e.g., a personal computer, a tablet and a smartphone. The information processing device 32 visualizes the information indicated by the data read out by the data reader 31. For example, the information processing device 32 visualizes the information indicated by the data read out by the data reader 31. For example, the information processing device 32 visualizes transition of values of variables defined in software embedded in the integrated circuit 1. Specifically, the information processing device 32 displays a graph or a time series of the values of the variables. By checking the transition of the values of the variables, the user verifies the execution operation of the software in the integrated circuit 1.

### <Problems of the Reference Embodiment>

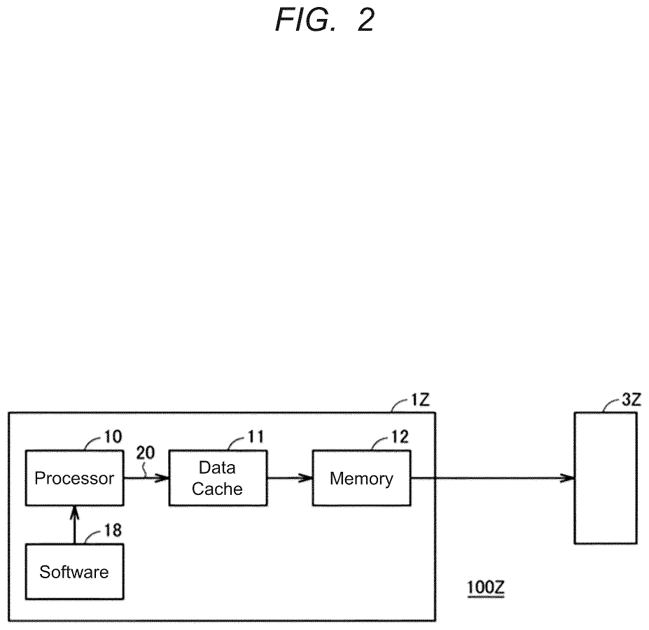

Before providing a detailed description of monitoring system 100 according to the present embodiment, the problems of the monitoring system related to the reference embodiment will be explained with reference to FIGS. 2 to 4.

FIG. 2 is a diagram showing the configuration of a monitoring system according to the reference form. The monitoring system 100Z according to the reference form includes an integrated circuit 1Z and a monitoring device 3Z instead of the integrated circuit 1 and the monitoring device 3.

The integrated circuit 1Z includes a processor 10, a data cache 11, and a memory 12.

Processor 10 executes software 18 created to realize desired functions and may include a CPU (Central Processing Unit) or a DSP (Digital Signal Processor).

The processor 10 executes software 18 and updates data in every predetermined control period. The processor 10 uses data when executing the software 18. Alternatively, the data are created by executing the software 18 by the processor 10. The data indicates the values of multiple variables defined in the software 18.

The memory 12 includes, for example, RAM (Random Access Memory). The memory 12 retains data specified in the software 18. In memory 12, data pieces representing the values of respective variables are written to addresses corresponding to those variables.

The data cache 11 is positioned between the processor 10 and the memory 12. The data cache 11 is connected to processor 10 via bus 20. The data cache 11 temporarily holds data pieces read from memory 12 and data pieces to be written to memory 12. Furthermore, the data cache 11 retains the corresponding addresses in memory 12 for each data piece.

The data cache 11 temporarily holds write data output from the processor 10 to be written to memory 12. For each of the one or more data pieces included in the write data, the data cache 11 also retains the corresponding address in memory 12.

The data cache 11 writes a portion of the data it holds to the memory 12 according to predetermined rules. For example, the data cache 11 writes data pieces with low read frequency to the memory 12 when the amount of data it holds reaches a specified value. Alternatively, the data cache 11 writes some or all of the data it holds to the memory 12 at predetermined timings. Therefore, the period from when the write data is output from the processor 10 to when it is written to the memory 12 can be sufficiently longer than the control cycle.

The data cache 11 receives a read instruction for a data piece from processor 10. The reading instruction specifies the address corresponding to the data piece to be read. If the data cache 11 holds the data piece corresponding to the specified address, it directly responds to the read instruction by passing the data piece to processor 10. If the data cache 11 does not hold the data piece corresponding to the specified address, it reads the data piece from memory 12 and indirectly responds to the read instruction by passing the data piece to processor 10.

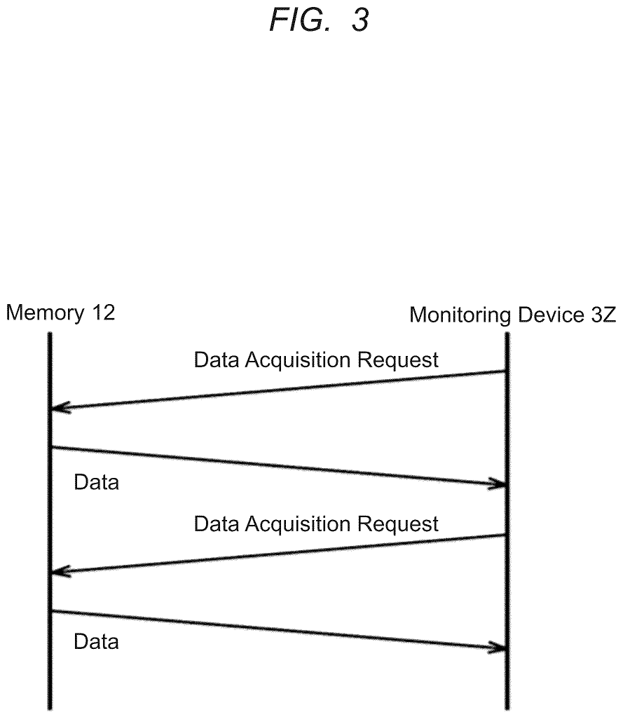

FIG. 3 is a diagram illustrating the monitoring of data by a monitoring device. The monitoring device 3Z monitors the data retained by memory 12. As shown in FIG. 3, the monitoring device 3Z periodically acquires data from memory 12 of the integrated circuit 1Z. For example, the monitoring device 3Z acquires data from memory 12 in accordance with the cycle in which the data to be acquired is updated. The cycle in which the data to be acquired is updated may be the same as the control cycle or maybe an integer multiple of the control cycle. Specifically, the monitoring device 3Z reads out the data piece (hereinafter referred to as “target data piece”) stored at the address corresponding to the variable to be monitored (hereinafter referred to as “target variable”) from memory 12.

However, as described above, the period from when the write data is output from the processor 10 to when it is written to the memory 12 can be sufficiently longer than the control cycle. That is, there exists a period during which the write data output from processor 10 is held only in the data cache 11 and not in memory 12. During this period, monitoring device 3Z cannot read the write data. In other words, the monitoring device 3Z reads old data from memory 12, not the updated data in the current control cycle. Therefore, when using the monitoring system 100Z according to the reference embodiment, the user cannot accurately verify the execution operation of the software 18 by the processor 10.

In monitoring system 100Z according to the reference embodiment, it is conceivable to match the data held by the data cache 11 with the data held by the memory 12 to monitor the updated data. A method known as write-back processing is known for matching the data held by the data cache 11 with the data held by the memory 12. Write-back processing is the process of writing data held in the data cache 11 to the memory 12. By executing the write-back processing immediately before the monitoring device 3Z acquires data from memory 12, the monitoring device 3Z can acquire the target data piece indicating the latest value of the target variable.

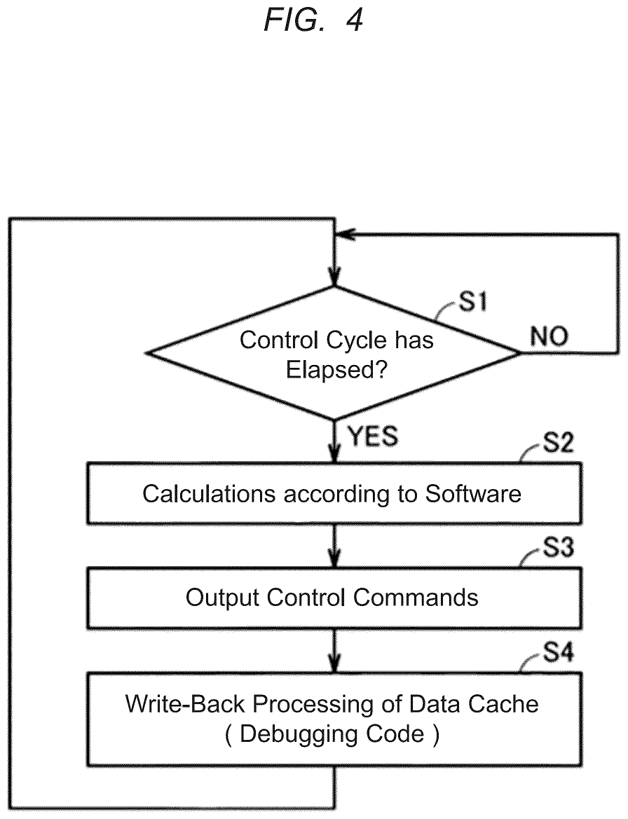

FIG. 4 is a flowchart illustrating an example of the control processing flow of the integrated circuit according to the reference embodiment. FIG. 4 shows the control processing flow including the write-back processing.

As shown in FIG. 4, processor 10 determines whether the control cycle has elapsed (step S1). If the control cycle has not elapsed (NO in step S1), the process returns to step S1. If the control cycle has elapsed (YES in step S1), the processor 10 performs calculations according to the software 18 (step S2). As a result, the values of various variables are calculated. Next, the processor 10 output control commands according to the calculation results (step S3). Next, the processor 10 outputs an instruction to execute the write-back processing to the data cache 11 (step S4). As a result, the data cache 11 writes the data it holds to the memory 12. After step S4, the process returns to step S1.

By executing step S4, the data held by the data cache 11 and the data held by the memory 12 become consistent. Step S4 is executed for each control cycle. Therefore, the consistency of the data between the data cache 11 and the memory 12 is ensured for each control cycle. As a result, the monitoring device 3Z can acquire the target data piece indicating the latest value of the target variable from memory 12.

However, processor 10 needs to wait from the time it outputs the instruction to execute the write-back processing until the write-back processing is completed. Therefore, the processing performance of the processor 10 decreases.

Additionally, the user needs to incorporate debugging code into the software 18 to execute the write-back processing. That is, the user's workload increases.

Furthermore, the write-back processing is only necessary for verifying the execution operation of software 18 in the integrated circuit 1Z. Therefore, the debugging code for executing the write-back processing is not usually incorporated into the integrated circuit 1Z as a final product distributed after verifying the execution operation of software 18. As a result, the performance of the integrated circuit 1Z evaluated during verification does not match the performance of the integrated circuit 1Z distributed after verification. In other words, the user cannot evaluate the performance equivalent to the actual final product distributed during verification.

Alternatively, in monitoring system 100Z according to the reference embodiment, it is conceivable to apply a cache-through mode to the integrated circuit 1Z to monitor the updated data. The cache-through mode is a mode in which write data is always written to both the data cache 11 and the memory 12. As a result, the monitoring device 3Z can acquire the data piece indicating the latest value of the target variable by accessing the memory 12.

However, when applying the cache-through mode to the integrated circuit 1Z, the number of accesses to the memory 12 increases. As a result, the processing performance of the processor 10 decreases.

Alternatively, in monitoring system 100Z according to the reference embodiment, the monitoring device 3Z may be designed to access not only memory 12 but also the data cache 11 to monitor the updated data.

For example, the monitoring device 3Z executes the following series of processes. First, the monitoring device 3Z refers to the addresses held in the data cache 11. If the address held in data cache 11 matches the address corresponding to the target variable, the monitoring device 3Z reads out the data piece indicating the value of the target variable from the data cache 11. If the address held in the data cache 11 does not match the address corresponding to the target variable, the monitoring device 3Z reads out the data piece indicating the value of the target variable from memory 12.

However, the monitoring device 3Z cannot synchronize the access timing to the data cache 11 with the control cycle. Therefore, during the execution of the above series of processes, the target data piece indicating the value of the target variable may be updated. Consequently, the monitoring device 3Z may not be able to acquire the latest target data piece.

The monitoring system 100 according to the present embodiment can solve the above problems in the monitoring system 100Z according to the reference embodiment.

### <Internal Configuration of the Monitoring System According to the Present Embodiment>

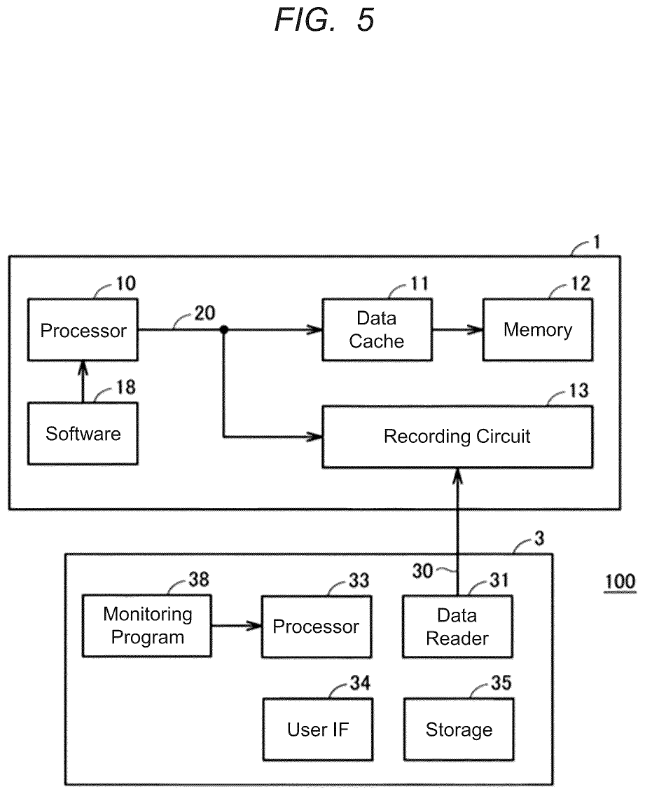

FIG. 5 is a block diagram showing an overview of the internal configuration of the monitoring system according to the present embodiment.

As shown in FIG. 5, the integrated circuit 1 includes a processor 10, a memory 12, a data cache 11, and a recording circuit 13. That is, the integrated circuit 1 differs from the integrated circuit 1Z shown in FIG. 2 in that it includes the recording circuit 13. Therefore, a detailed description of processor 10, data cache 11, and memory 12 are omitted. Note that processor 10 is an example of the “first processor” described in this disclosure. Memory 12 is an example of the “first memory” described in this disclosure.

The recording circuit 13 is connected to bus 20 between processor 10 and data cache 11. The recording circuit 13 records the write data output from the processor 10 to be written to the memory 12. The write data is generated by processor 10 executing the software 18.

According to the integrated circuit 1 of the present embodiment, the write data output from processor 10 is recorded in the recording circuit 13. Therefore, the user can monitor the data recorded in the recording circuit 13 to confirm the latest data. As a result, the user can more accurately verify the execution operation of software 18 by processor 10.

Furthermore, according to the integrated circuit 1 of the present embodiment, there is no need to apply a writeback process. Therefore, compared to a reference form in which a write-back process is applied to the integrated circuit 1Z, the work of incorporating debug code is omitted.

Moreover, by processor 10 outputting the write data to the bus 20, the write data is automatically recorded in the recording circuit 13. Therefore, compared to a reference form in which a write-back process or cache-through mode is applied to the integrated circuit 1Z, the performance degradation of processor 10 is suppressed.

Monitoring device 3 includes a debug interface 30, a data reader 31, a processor 33, a user interface 34, and a storage 35. The processor 33, user interface 34, and storage 35 are built into the information processing device 32 shown in FIG. 1.

The debug interface 30 is connected to recording circuit 13. The data reader 31 accesses the recording circuit 13 and reads the write data recorded in the recording circuit 13.

The processor 33 executes monitoring program 38. Specifically, processor 33 performs the data acquisition process from the integrated circuit 1 and the data visualization process. Furthermore, processor 33 may set the operating conditions of recording circuit 13. Note that processor 33 is an example of the “second processor” described in this disclosure.

The user interface 34 provides information to the user. Specifically, the user interface 34 visualizes the transition of the values of one or more target variables indicated by the write data. Furthermore, the user interface 34 accepts input from the user. The user interface 34 includes, for example, a display, keyboard, mouse, and touch panel.

According to monitoring system 100 of the present embodiment, the user can confirm the transition of the values of the variables visualized by the user interface 34. As a result, the user can more accurately verify the execution operation of software 18 by processor 10.

### Example 1

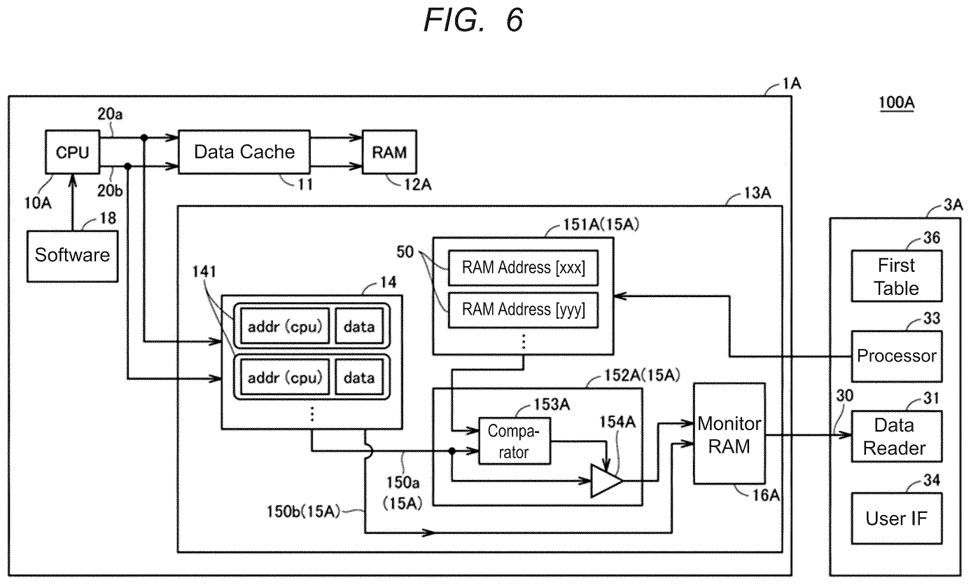

FIG. 6 is a diagram showing the configuration of Example 1 of the monitoring system according to the present embodiment. As shown in FIG. 6, the monitoring system 100A according to Example 1 includes an integrated circuit 1A and a monitoring device 3A.

The integrated circuit 1A is an example of the integrated circuit 1 shown in FIG. 5. The integrated circuit 1A includes a CPU 10A, a data cache 11, a RAM 12A, and a recording circuit 13A. CPU 10A is an example of the processor 10 shown in FIG. 5. RAM 12A is an example of memory 12 shown in FIG. 5. The recording circuit 13A is an example of the recording circuit 13 shown in FIG. 5.

The CPU 10A and the data cache 11 are connected to each other via an address bus 20a and a data bus 20b. The CPU 10A outputs a signal indicating the written data to be written to the RAM 12A to the data bus 20b. Furthermore, the CPU 10A outputs a signal indicating the corresponding address on the RAM 12A for one or more data pieces constituting the write data to the address bus 20a.

The recording circuit 13A includes a buffer 14, a write circuit 15A, and a monitor RAM 16A.

The buffer 14 is connected to the address bus 20a and the data bus 20b. The buffer 14 temporarily accumulates the write data transmitted on the data bus 20b. Specifically, the buffer 14 accumulates a data set 141 for each of one or more data pieces included in the write data. The data set 141 includes the data piece and the corresponding address on RAM 12A.

The write circuit 15A writes the write data accumulated in buffer 14 to the monitor RAM 16A. The write circuit 15A includes an address bus 150a, a data bus 150b, a storage circuit 151A, and a comparison circuit 152A.

One end of each of the address bus 150a and the data bus 150b is connected to the buffer 14. Signals indicating each data set 141 accumulated in the buffer 14 are sequentially output to the address bus 150a and the data bus 150b. That is, signals indicating the data pieces included in the data set 141 are output to the data bus 150b. Signals indicating the addresses included in the data set 141 are output to the address bus 150a. The other end of the data bus 150b is connected to the monitor RAM 16A.

The storage circuit 151A stores one or more monitor target addresses 50 corresponding to one or more target variables. The monitor target address 50 is the address of the area in the RAM 12A where the corresponding target variable is stored. The monitor target address 50 corresponds to the “first address” described in this disclosure. One or more monitor target addresses 50 are set by monitoring device 3A.

The comparison circuit 152A is connected to the address bus 150a and the storage circuit 151A. The comparison circuit 152A includes a comparator 153A and a gate switch 154A.

The first input terminal of the comparator 153A sequentially receives one or more monitor target addresses 50 stored in the storage circuit 151A. The second input terminal of the comparator 153A is connected to the address bus 150a. Thus, the comparator 153A compares the address received from the address bus 150a with one or more monitor target addresses 50 stored in the storage circuit 151A in sequence. When the address received from the address bus 150a matches any of the one or more monitor target addresses 50, the comparator 153A outputs an on signal indicating a match. When the address received from the address bus 150a does not match any of the one or more monitor target addresses 50, the comparator 153A outputs an off signal indicating no match.

The input terminal of the gate switch 154A is connected to the address bus 150a. The output terminal of the gate switch 154A is connected to the monitor RAM 16A. The gate switch 154A outputs the signal input to its input terminal from its output terminal when it receives an on signal from the comparator 153A. The gate switch 154A does not output the signal input to its input terminal from its output terminal when it receives an off signal from the comparator 153A.

Thus, the comparison circuit 152A outputs the address received from the address bus 150a to the monitor RAM 16A when the address matches any of the one or more monitor target addresses 50. The comparison circuit 152A does not output the address received from the address bus 150a to the monitor RAM 16A when the address does not match any of the one or more monitor target addresses 50.

The other end of the data bus 150b is connected to the monitor RAM 16A. In the monitor RAM 16A, only the data piece transferred along with the address is written into the area of the corresponding address. Only addresses that match the monitor target addresses 50 are output to the monitor RAM 16A. Therefore, the write circuit 15A writes one or more target data pieces from the write data accumulated in the buffer 14 into the monitor RAM 16A. The one or more target data pieces are, as described above, one or more data pieces written to one or more monitor target addresses 50 in RAM 12A.

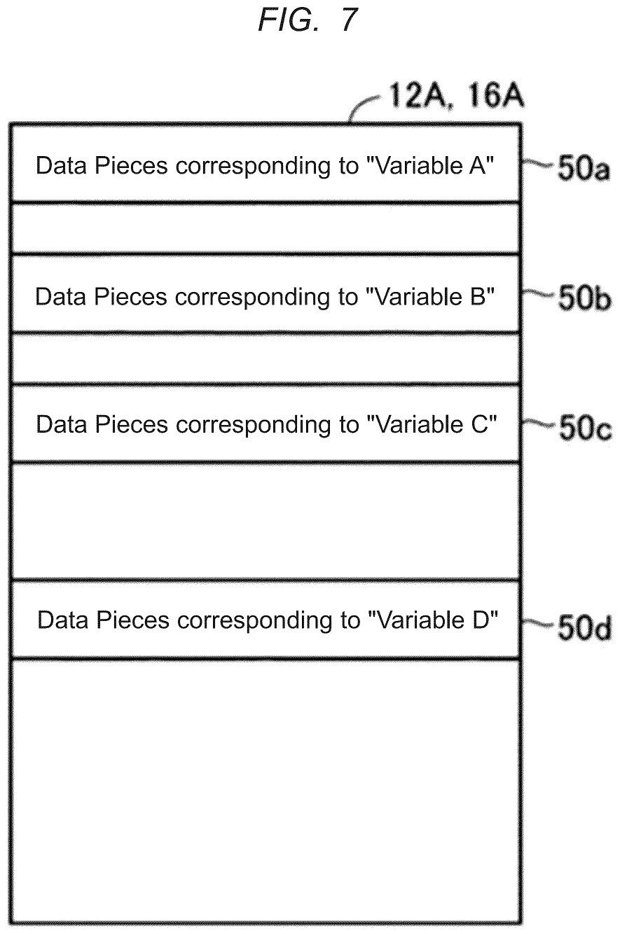

FIG. 7 is a diagram showing the storage status of data in Example 1. The monitor RAM 16A has the same capacity as or a larger capacity than the RAM 12A. Therefore, all addresses in the monitor RAM 16A include all addresses in RAM 12A. In the example shown in FIG. 7, the monitor RAM 16A has the same capacity as RAM 12A.

FIG. 7 shows an example when “Variable A” to “Variable D” are selected as target variables. As shown in FIG. 7, in RAM 12A, the target data pieces indicating the values of “Variable A” to “Variable D” are stored in the corresponding monitor target addresses 50a to 50b, respectively. The write circuit 15A, according to Example 1 writes one or more target data pieces to the same addresses as one or more monitor target addresses 50 respectively in the monitor RAM 16A. Therefore, in monitor RAM 16A, the target data pieces indicating the values of “Variable A” to “Variable D” are stored at the same addresses as in RAM 12A (i.e., monitor target addresses 50a to 50d).

Note that since data cache 11 is arranged between the RAM 12A and the CPU 10A, the write data is temporarily held in the data cache 11. The retention time of the write data by the data cache 11 is significantly longer than the accumulation time of the write data by the buffer 14. The accumulation time of the write data by the buffer 14 is usually shorter than the control cycle. Therefore, if the write data of a certain control cycle includes the target data piece of “Variable A” corresponding to the monitor target address 50a, the following situation may occur after the certain control cycle. That is, the data piece stored in the monitor target address 50a in the monitor RAM 16A indicates the updated value, while the data piece stored in the monitor target address 50a in the RAM 12A may indicate the value before the update.

The monitoring device 3A shown in FIG. 6 is an embodiment of monitoring device 3 shown in FIG. 5. The monitoring device 3A includes a debug interface 30, a data reader 31, a processor 33, a user interface 34, and a first table 36. The first table 36 is stored in the storage 35 shown in FIG. 5.

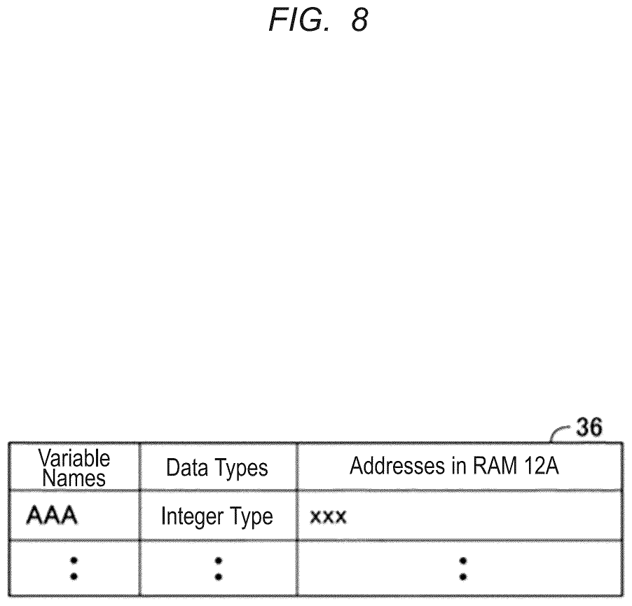

FIG. 8 is a diagram showing an example of the first table. As shown in FIG. 8, the first table 36 associates the variable names, data types, and addresses in RAM 12A for each of the multiple variables defined in software 18. The first table 36 is created by the tool used to develop the software 18 after compiling or building the software 18.

The user interface 34 accepts the specification of one or more target variables among the multiple variables defined in the software 18. For example, the user interface 34 displays a list of multiple variables included in the first table 36. The user interface 34 prompts the user to specify the target variables from the list.

The processor 33 refers to the first table 36 to identify one or more addresses where data pieces indicating one or more target variables are written respectively in RAM 12A as one or more monitor target addresses 50. The processor 33 sets one or more monitor target addresses 50 in the storage circuit 151A.

In the monitoring system 100A according to Example 1, the debug interface 30 is connected to the monitor RAM 16A instead of the RAM 12A. Therefore, the data reader 31 reads data from the monitor RAM 16A. As described above, the write data is immediately written into the monitor RAM 16A. Therefore, the data reader 31 can obtain data pieces indicating the latest values for each target variable from the monitor RAM 16A.

The user interface 34 visualizes the transition of the values of each target variable based on the data pieces obtained by the data reader 31. This allows the user to more accurately verify the execution operation of the software 18 by the CPU 10A based on the transition of the values of each target variable.

Next, the comparison results between the processing performance of the processor 10 in the reference form monitoring system 100Z and the processing performance of the CPU 10A in the monitoring system 100A according to Example 1 are described. The processing performance of the processor 10 or CPU 10A is evaluated by the average access ratio to the memory 12 or RAM 12A during the control cycle.

The average access ratio is calculated based on the following conditions (a) to (d).

(a) In the monitoring system 100Z according to the reference form, a write-back process is performed for each control cycle. The time required for the write-back process is 200 ns per 4 bytes.

(b) The access time to the data cache is 25 ns per 4 bytes.

(c) The amount of data to be accessed is 256 bytes.

(d) The control cycle for executing the software 18 is 1 msec.

In monitoring system 100Z according to the reference form, the time (average access time) for the processor 10 to access the data is calculated as 206.4 microseconds based on the following equation (1).

Average access time={(amount of data to be accessed)/4}multiplied by (access time to data cache)+(time required for write-back process)

=(256/4) multiplied by 25+(256/4) multiplied by 200

=206400 ns equation (1).

Therefore, the average access ratio to memory 12 during the control cycle is 20.6% (20.6 percent).

In the monitoring system 100A according to Example 1, the time (average access time) for the CPU 10A to access the data is calculated as 1.6 microseconds based on the following equation (2).

$$Average access time = \{ ( amount of data to be accessed ) / 4 \} multiplied by ( access time to data cache ) = ( 256 / 4 ) multiplied by 25 = 1600 ns . \qquad equation ( 2 )$$

Therefore, the average access ratio to the RAM 12A during the control cycle is 0.16%.

Thus, the processing performance of the CPU 10A according to Example 1 is improved by approximately 20% compared to the processing performance of the processor 10 according to the reference form.

### Example 2

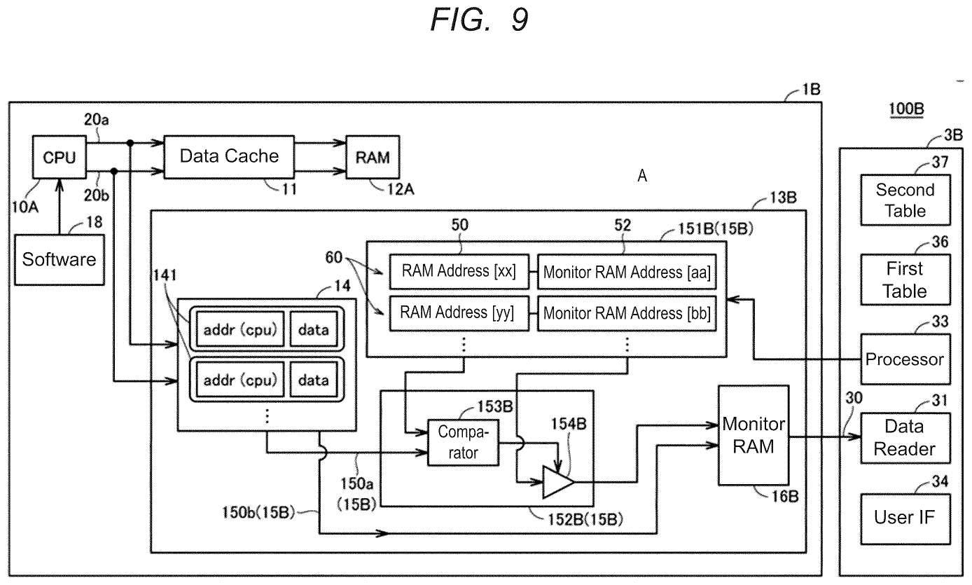

FIG. 9 is a diagram showing the configuration of Example 2 of the monitoring system according to the present embodiment. As shown in FIG. 9, the monitoring system 100B according to Example 2 includes an integrated circuit 1B and a monitoring device 3B.

The integrated circuit 1B is an embodiment of the integrated circuit 1 shown in FIG. 5. The integrated circuit 1B differs from the integrated circuit 1A shown in FIG. 6 in that it includes a recording circuit 13B instead of the recording circuit 13A. The recording circuit 13B is an example of the recording circuit 13 shown in FIG. 5.

The recording circuit 13B differs from the recording circuit 13A in that it includes a write circuit 15B and a monitor RAM 16B instead of the write circuit 15A and the monitor RAM 16A. The write circuit 15B differs from the write circuit 15A in that it includes a storage circuit 151B and a comparison circuit 152B instead of the storage circuit 151A and the comparison circuit 152A.

The storage circuit 151B stores an address set 60 for each of one or more target variables. The address set 60 includes a monitor target address 50 in RAM 12A and a post-conversion address 52 in monitor RAM 16B. In other words, the storage circuit 151B stores one or more monitor target addresses 50, similar to the storage circuit 151A. Furthermore, the storage circuit 151B stores one or more post-conversion addresses 52 in association with one or more monitor target addresses 50 in the monitor RAM 16B. The one or more post-conversion addresses 52 are set by monitoring device 3B.

The comparison circuit 152B sequentially reads one or more address sets 60 stored in the storage circuit 151B. The comparison circuit 152B includes a comparator 153B and a gate switch 154B.

The monitor target address 50 included in the address set 60 is input to the first input terminal of the comparator 153B. The second input terminal of the comparator 153B is connected to the address bus 150a. Thus, the comparator 153B sequentially compares the address received from the address bus 150a with one or more monitor target addresses 50 stored in storage circuit 151B. When the address received from the address bus 150a matches the monitor target address 50, the comparator 153B outputs an on-signal indicating a match. When the address received from the address bus 150a does not match the monitor target address 50, the comparator 153B outputs an off signal indicating a mismatch.

The post-conversion address 52 included in the address set 60 is input to the input terminal of the gate switch 154B. The output terminal of the gate switch 154B is connected to the monitor RAM 16B. Upon receiving an on-signal from the comparator 153B, the gate switch 154B outputs the signal input to its input terminal from its output terminal. The gate switch 154B does not output the signal input to its input terminal from its output terminal when it receives an off signal from the comparator 153B.

Thus, the comparison circuit 152B outputs the post-conversion address 52 corresponding to a certain monitor target address 50 to the monitor RAM 16B in response to the address received from the address bus 150a matching the certain monitor target address 50. The comparison circuit 152B does not output an address to the monitor RAM 16A when the address received from the address bus 150a does not match any of the one or more monitor target addresses 50.

The other end of the data bus 150b is connected to the monitor RAM 16B. In monitor RAM 16B, only the data piece transferred along with the address is written into the area of the address. The post-conversion address 52 corresponding to the monitor target address 50 is output to the monitor RAM 16B. The monitor target address 50 indicates the area in RAM 12A where the target data piece showing the value of the target variable is stored. Therefore, the write circuit 15B writes one or more target data pieces from the write data accumulated in the buffer 14 into the monitor RAM 16B. At this time, one or more target data pieces are written into one or more post-conversion addresses 52 in the monitor RAM 16B, respectively.

One or more post-conversion addresses 52 are set so that one or more target data pieces are recorded continuously from the head address of the monitor RAM 16B.

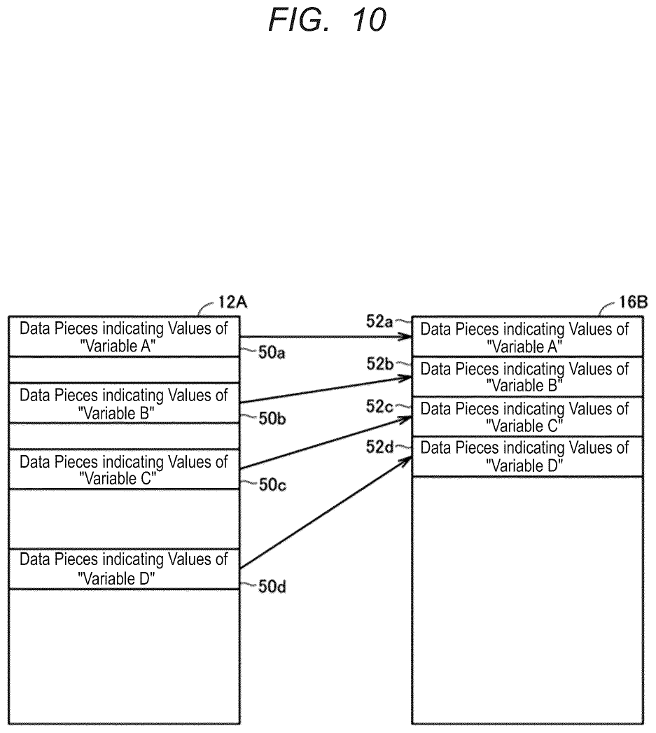

FIG. 10 is a diagram showing the storage status of data in Example 2. FIG. 10 shows an example when “Variable A” to “Variable D” are selected as target variables. As shown in FIG. 10, in RAM 12A, four target data pieces indicating the values of “Variable A” to “Variable D” are stored in the corresponding monitor target addresses 50a to 50d, respectively. In contrast, the write circuit 15B according to Example 2 writes four target data pieces indicating the values of “Variable A” to “Variable D” into the post-conversion addresses 52a to 52d in the monitor RAM 16B, respectively. The post-conversion addresses 52a to 52d are set so that four target data pieces are recorded continuously from the head address of the monitor RAM 16B. Therefore, the write circuit 15B writes four target data pieces indicating the values of “Variable A” to “Variable D” continuously from the head address of the monitor RAM 16B.

In this way, in the monitor RAM 16B, the storage area uses only the total capacity of one or more target data pieces from the head address. Therefore, the capacity of the monitor RAM 16B can be smaller than that of the RAM 12A.

The monitoring device 3B shown in FIG. 9 is an embodiment of monitoring device 3 shown in FIG. 5. The monitoring device 3B differs from the monitoring device 3A shown in FIG. 6 in that it further includes a second table 37. The second table 37 is stored in the storage 35 shown in FIG. 5.

In Example 2, the user interface 34 also accepts the designation of one or more target variables among the multiple variables defined in the software 18. Then, processor 33 refers to the first table 36 to identify one or more monitor target addresses where data pieces indicating one or more target variables are written in RAM 12A. The processor 33 sets one or more monitor target addresses in the storage circuit 151B.

Furthermore, processor 33 determines post-conversion address 52 for each of one or more target variables. The post-conversion address 52 defines the area where the target data piece indicating the value of the corresponding target variable is written in the monitor RAM 16B. The processor 33 determines one or more post-conversion addresses 52 so that one or more target data pieces corresponding to one or more target variables are recorded continuously from the head address of the monitor RAM 16B. The processor 33 creates the second table 37 including the determined post-conversion address 52.

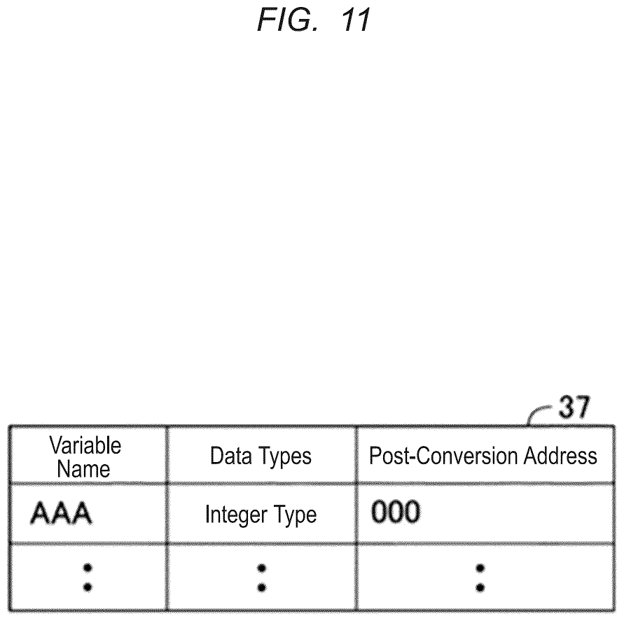

FIG. 11 is a diagram showing an example of the second table. As shown in FIG. 11, the second table 37 associates the variable name, data type, and post-conversion address for each of one or more target variables.

In the monitoring system 100B according to Example 2, the debug interface 30 is connected to the monitor RAM 16B instead of the RAM 12A. Therefore, the data reader 31 reads data from the monitor RAM 16B. In the monitor RAM 16B, as in Example 1, the write data is written immediately. Therefore, the data reader 31 can obtain the target data piece indicating the latest value for each target variable from the monitor RAM 16B. In Example 2, as described above, one or more target data pieces are written continuously from the head address of the monitor RAM 16B. Therefore, when one or more target data pieces include multiple target data pieces, the data reader 31 reads multiple target data pieces collectively from the monitor RAM 16B. In other words, the data reader 31 reads a set of multiple target data pieces (hereinafter referred to as “data piece set”). This reduces the communication volume between the monitoring device 3B and the monitor RAM 16B.

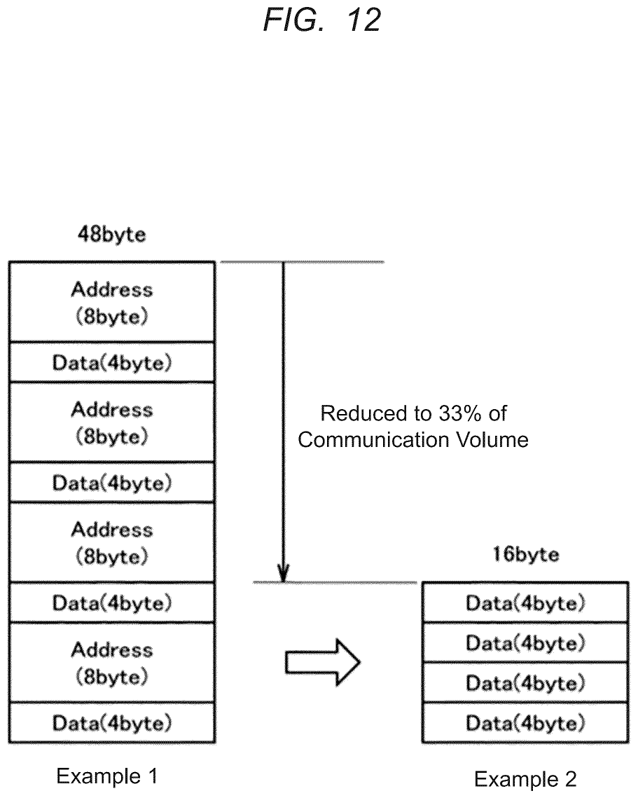

FIG. 12 is a diagram explaining the effect of reducing the communication volume between the monitoring device and monitor RAM. FIG. 12 shows an example of when four target variables are set.

In Example 1, as shown in FIG. 7, four target data pieces indicating the values of four target variables are written into four discontinuous areas of monitor RAM 16A, respectively. Therefore, the data reader 31 outputs a signal specifying the address (the same address as the monitor target address 50) where the corresponding target data piece is stored for each of the four target variables to the monitor RAM 16A. Then, a signal indicating the target data piece stored at the specified address is transmitted from monitor RAM 16A to the data reader 31. When the address is represented by 8 bytes and the data piece is represented by 4 bytes, the communication volume between the data reader 31 and the monitor RAM 16A is (8+4) multiplied by 4=48 bytes.

In contrast, in Example 2, as shown in FIG. 10, four target data pieces indicating the values of four target variables are written into a continuous area from the head address of monitor RAM 16B. Therefore, the signals indicating the four target data pieces are transmitted collectively from the monitor RAM 16A to data reader 31. Thus, when the data piece is represented by 4 bytes, the communication volume between the data reader 31 and the monitor RAM 16B is 4 multiplied by 4=16 bytes. In this way, the communication volume in Example 2 is reduced to 33% of the communication volume in Example 1.

As described above, the data reader 31 reads a set of multiple target data pieces (data piece set). Therefore, processor 33 refers to the second table 37 and analyzes the data piece set. The processor 33 identifies the value of each of the multiple target variables based on the analysis results.

### Example 3

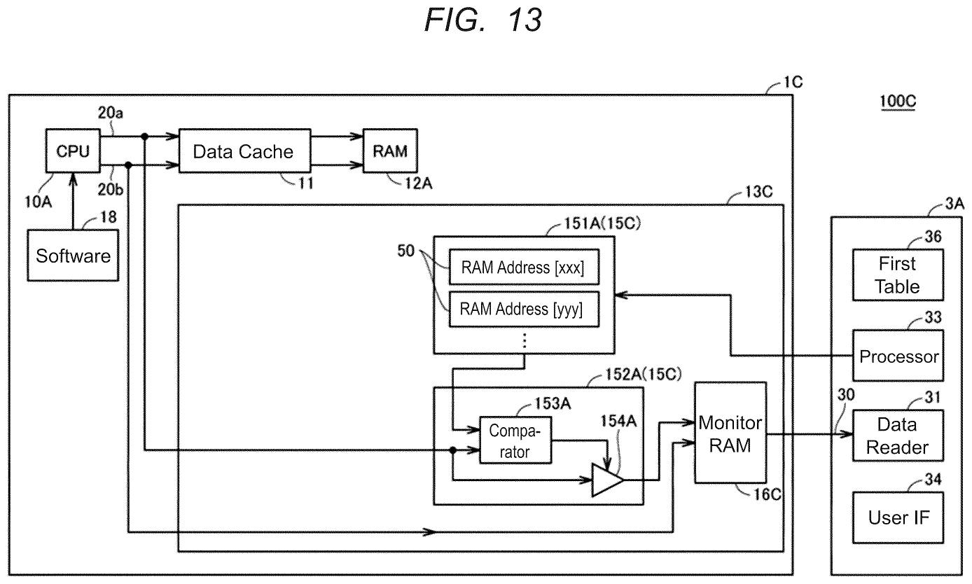

FIG. 13 illustrates the configuration of Example 3 of the monitoring system according to the present embodiment. As shown in FIG. 13, the monitoring system 100C according to Example 3 differs from the monitoring system 100A shown in FIG. 6 in that it includes an integrated circuit 1C instead of the integrated circuit 1A.

The integrated circuit 1C is an embodiment of the integrated circuit 1 shown in FIG. 5. The integrated circuit 1C differs from the integrated circuit 1A shown in FIG. 6 in that it includes a recording circuit 13C instead of the recording circuit 13A. The recording circuit 13C is an example of the recording circuit 13 shown in FIG. 5.

The recording circuit 13C differs from the recording circuit 13A in that it includes a write circuit 15C and a monitor RAM 16C instead of the write circuit 15A and the monitor RAM 16A, and it does not include a buffer 14.

The write circuit 15C differs from the write circuit 15A in that it does not include an address bus 150a and a data bus 150b. The second input terminal of the comparator 153A is connected to the address bus 20a.

The monitor RAM 16C can be accessed faster than the RAM 12A from the outside. Specifically, the access speed to the monitor RAM 16C is equal to or greater than the access speed to the data cache 11. The monitor RAM 16C is connected to the data bus 20b.

According to the integrated circuit 1C of Example 3, the write data output from the processor 10 to the data bus 20b is recorded in the monitor RAM 16C at the same timing as it is held in the data cache 11. The data recorded in the monitor RAM 16C is acquired by monitoring device 3A. This allows the user to more accurately verify the execution operation of software 18 by the CPU 10A by checking the data acquired by monitoring device 3A.

Although the invention made by the present inventor has been specifically described based on the embodiment, the present invention is not limited to the embodiment described above, and it is needless to say that various modifications can be made without departing from the gist thereof.

What is claimed is:

1. An integrated circuit comprising:
a processor;
a first memory for storing data defined in software executed by the processor;
a data cache disposed between the processor and the first memory, the data cache temporarily holding write data output from the processor to be written to the first memory; and
a recording circuit connected to a bus between the processor and the data cache, which recording circuit records the write data.

2. The integrated circuit according to claim 1, wherein the recording circuit comprises:
a buffer temporarily accumulating the write data;
a second memory; and
a write circuit for writing the write data accumulated in the buffer into the second memory.

3. The integrated circuit according to claim 2, wherein the write circuit writes one or more target data pieces in the write data into the second memory, the target data pieces being written into one or more first addresses in the first memory.

4. The integrated circuit according to claim 3, wherein the write circuit writes, in the second memory, the one or more target data pieces into addresses same as the one or more first addresses, respectively.

5. The integrated circuit according to claim 3, wherein the write circuit
converts the one or more first addresses into one or more second addresses in the second memory, respectively; and
writes, in the second memory, the one or more target data pieces into the one or more second addresses, respectively,
wherein the one or more second addresses are set such that the one or more target data pieces are recorded consecutively from a head address of the second memory.

6. The integrated circuit according to claim 5, wherein the capacity of the second memory is less than the capacity of the first memory.

7. The integrated circuit according to claim 1, wherein the recording circuit comprises:
a second memory, which is accessible at a higher speed than the first memory; and
a write circuit for writing the write data to the second memory.

8. A monitoring system comprising:
an integrated circuit; and
a monitoring device,
wherein the integrated circuit includes:
a first processor;
a first memory storing data defined in software executed by the first processor;
a data cache disposed between the first processor and the first memory, the data cache temporarily holding write data output from the first processor to be written into the first memory; and
a recording circuit connected to a bus between the first processor and the data cache, for recording the write data,
wherein the monitoring device includes:
a data reader accessing the recording circuit to read the write data; and
a user interface for visualizing transition of values of one or more valuables indicated by the write data.

9. The monitoring system according to claim 8, wherein the recording circuit comprises:
a buffer for temporarily accumulating the write data;
a second memory; and
a write circuit for writing the write data accumulated in the buffer into the second memory,
wherein the user interface receives a specification of one or more target variables among a plurality of variables defined in the software,
wherein the monitoring device further includes a second processor for specifying, in the first memory, one or more first addresses into which one or more target data pieces indicating the one or more target variables, respectively, are written, respectively, and
wherein the write circuit writes the one or more target data pieces among the write data into the second memory.

10. The monitoring system according to claim 9, wherein the write circuit:
converts the one or more first addresses into one or more second addresses in the second memory; and
writes, in the second memory, the one or more target data pieces into the one or more second addresses, and
wherein the second processor sets the one or more second addresses such that the one or more target data pieces are recorded consecutively from a head address of the second memory.

11. The monitoring system according to claim 10,
wherein the one or more target variables include a plurality of target variables;
wherein the one or more target data pieces include a plurality of target data pieces indicating values of the plurality of target variables;
wherein the data reader reads a set of the plurality of target data pieces at once from the head address of the second memory; and
wherein the second processor analyzes the set to specify the respective values of the plurality of target variables.
